(19) United States
(12) Patent Application Publication
(10) Pub. No.: US 2014/0270701 A1
(43) Pub. Date: Sep. 18, 2014

(54) METHOD ON INDEXING A RECORDABLE EVENT FROM A VIDEO RECORDING AND SEARCHING A DATABASE OF RECORDABLE EVENTS ON A HARD DRIVE OF A COMPUTER FOR A RECORDABLE EVENT

(71) Applicant: FIRST PRINCIPLES, INC., Albany, NY (US)

(72) Inventor: Keith A. Raniere, Clifton Park, NY (US)

(73) Assignee: FIRST PRINCIPLES, INC., ALBANY, NY (US)

(21) Appl. No.: 13/838,979

(22) Filed: Mar. 15, 2013

(51) Int. Cl. G11B 27/28; H04N 9/79

(52) U.S. Cl. CPC G11B 27/28; H04N 9/79
USPC 386/241

(57) ABSTRACT

A method of indexing recordable events from a video recording, a first method of searching a video recording for a recordable event on a hard drive of a computer, and a second method of searching a video recording for a recordable event on a hard drive of a computer is provided.

### BACKGROUND

1. Field of Technology

The present invention relates generally to the indexing of a recoverable event from a video recording and searching of a database of recordable events for a recordable event.

2. Related Art

Various apparatus and methods have been developed for indexing, searching and retrieving audio and/or video content. A method of indexing, searching and retrieving audio and/or video content, which involves converting an entry such as an audio track, song or voice message in a digital audio database (e.g., a cassette tape, optical disk, digital video disk, videotape, flash memory of a telephone answering system or hard drive of a voice messaging system) from speech into textual information is set forth in Kermani, U.S. Pat. No. 6,697,796. Another method and apparatus, set forth in U.S. Pat. No. 6,603,921 to Kanevsky et al., involve indexing, searching and retrieving audio and/or video content in pyramidal layers, including a layer of recognized utterances, a global word index layer, a recognized word-bag layer, a recognized word-lattices layer, a compressed audio archival layer and a first archival layer. Kavensky provides a textual search of the pyramidal layers of recognized text, including the global word index layer, the recognized word-bag layer and the recognized word-lattices layer because the automatic speech recognition transcribes audio to layers of recognized text. Yang et al., U.S. Pat. No. 5,819,286 provides a video database indexing and query method. The method includes, indicating the distance between each symbol of each graphical icon in the video query in the horizontal, vertical and temporal directions by a 3-D string. The method further includes identifying video clips that have signatures like the video query signatures by determining whether the video query signature constitutes a subset of the database video clip signature. Kermani, U.S. Pat. No. 6,697,796, Kanevsky et al., U.S. Pat. No. 6,603,921 and Yang et al., U.S. Pat. No. 5,819,286 do not provide a method of indexing the content of a video recording by human reaction to the content. There is a need for the indexing of recoverable events from video recordings by human reaction to the content and searching the video recording for content.

### SUMMARY

A method of indexing a recordable event from a video recording, said method comprising: (a) analyzing said video recording for a said recoverable event through human impression; (b) digitizing said a recordable event on a hard drive of a computer; (c) digitally tagging or marking said a recordable event of said video recording; (d) associating a digital tagged or marked recoverable event with an indexer keyword; and (e) compiling said digitally tagged or marked recoverable event on a database of recoverable events for searching and retrieving content of said video recording.

A method of searching a video recording for a recordable event on a hard drive of a computer, said method comprising: (a) inputting a user defined criterion into a user input device; (b) processing said user defined criterion communicated to a processor; (c) comparing said user defined criterion to a recoverable event of a database of recoverable events; and (d) displaying a selection list of recoverable events matching said user defined criterion. In another aspect, a method of searching a video recording for a recordable event on a hard drive of a computer, said method comprising: (a) inputting a user defined criterion into a user input device; (b) creating a composite list from said user defined criterion; (c) processing said composite list communicated to a processor; (d) comparing said composite list to a recoverable event of a database of recoverable events; and (e) displaying a selection list of recoverable events matching said composite list.

### BRIEF DESCRIPTION OF THE DRAWINGS

FIG. 1 illustrates a method of indexing a recordable event from a video recording.

FIG. 2 provides a simplified diagram for examples of recordable events.

FIG. 3 depicts a method of analyzing a video recording for a recoverable event through human impression.

FIG. 4 is an example of a method of analyzing a video recording for a recoverable event through human impression by at least one individual.

FIG. 5 provides examples for a level of funniness, a level of seriousness, a level of inspiration, a level of passion, a level of audience reaction.

FIG. 6 provides examples for a level of funniness, a level of seriousness, a level of inspiration, a level of passion, a level of audience reaction.

FIG. 7 provides an example for a method of analyzing a video recording for a recordable event through human impression by each of a member of at least one group.

FIG. 8 provides an example for a method of analyzing a video recording for a recordable event through human impression by each of a member of at least one group.

FIG. 9 provides an example for a method of analyzing a video recording for at least one of a same recordable event by at least two individuals through human impression.

FIG. 10 illustrates an example of a method of analyzing a video recording for at least one of a same recoverable event through human impression by at least one member of a first group and at least one member of a second group.

FIG. 11 illustrates the linking of various video sources to a computer for indexing of a recordable event from a video recording.

FIG. 12 illustrates a method of digitizing a recordable event on a hard drive of a computer.

FIG. 13 illustrates a method of digitally tagging or marking a recordable event of a video recording on a hard drive of a computer.

FIG. 14 depicts a method of associating a digital tagged or marked recoverable event with an indexer keyword.

FIG. 15 depicts a method of compiling a digital tagged or marked recoverable event in a database of recoverable events for searching and retrieving content of a video recording.

FIG. 16 illustrates a method of rating a perceived recoverable event through human impression using a rating criterion.

FIG. 17 illustrates a method of digitizing a recordable event on a workstation.

FIG. 18 depicts an exemplary embodiment of the video system.

FIG. 19 depicts block diagram illustrating a method of searching a video recording for content by inputting a user defined criterion using a user input device.

FIG. 20 depicts a diagram of a method of searching a video recording for a recordable event for content by inputting a user defined criterion into a graphical user interface.

FIG. 21 depicts a block diagram of a method of searching using a user defined criterion, including parsing of a user defined criterion.

FIG. 22 depicts a block diagram of a method of searching using a composite list, including parsing of a user defined criterion and creating a composite list.

### DETAILED DESCRIPTION

The present invention provides a method for indexing a recordable event from a video recording and a method of searching the video recording for content (i.e., recoverable event, topic, subject). The present invention will be described in association with references to drawings; however, various implementations of the present invention will be apparent to those skilled in the art.

In one aspect, the present invention is a method of indexing a recordable event from a video recording, comprising analyzing the video recording for recoverable events through human impression in step 101 of FIG. 1, digitizing the recordable events on the hard drive of a computer step 104, digitally tagging or marking the recordable event of the video recording on the hard drive of the computer in step 105 and associating the recoverable event with an indexer keyword such as a criterion of human impression analysis in step 106 and compiling a database of recoverable events on the hard drive of the computer in step 107.

Human impression is a human reaction to or human inference from information received by one or more human senses such as sight, sound, touch and smell. For example, when an individual discerns an extra pause of a speaker, the individual may perceive the extra pause as humor. While listening to a speaker's lecture, an individual may perceive that one or more of the speaker's statements are interesting and quotable. In reaction to seeing an artistic work in a museum, an individual may perceive that the artistic work has qualities, attributes or properties of a chair.

In accordance with step 101 of FIG. 1, the method of indexing a recordable event from a video recording comprises analyzing the video recording for recoverable events through human impression. FIG. 3 shows a method of analyzing the video recording for a recordable event through human impression. FIG. 2 depicts a simplified diagram for examples of recoverable events. A recordable event includes, but is not limited to an intellectual point, a quote, a metaphor, a joke, a gesture, an antic, a laugh, a concept, a content, a character, an integration, a sound, a sourcing, a story, a question, an athletic form, an athletic performance, a circus performance, a stunt, an accident. The method of analyzing the video recording includes viewing the video recording by at least one individual in step 301, identifying each perceived occurrence of a recoverable event in the video recording through human impression in step 302, recording each perceived occurrence of the recoverable event in step 303 and recording a time location corresponding to each perceived occurrence of the recoverable event for the video recording in step 304. Each perceived occurrence of the recoverable event and time location corresponding to each perceived occurrence of the recoverable event for the video recording may be manually recorded.

FIG. 4 is an example of a method of analyzing a video recording for a recoverable event through human impression by at least one individual (i.e., record taker, note taker). A first individual may analyze the video recording for intellectual points in FIG. 4. The first individual views the video recording in step 401a, identifies each perceived occurrence of an intellectual point in the video recording in step 402a, manually records a description of each perceived occurrence of the intellectual point in step 403a and manually records the time location corresponding to each perceived occurrence of the intellectual point in the video recording in step 404a. A second individual may simultaneously view the video recording in step 401b and analyze the video recording for jokes as shown in FIG. 4. While reviewing the video recording, the second individual identifies each perceived occurrence of a joke (i.e., joke about a task, joke about an author of literary work) in the video recording in step 402b, manually records a description of each perceived occurrence of the joke in step 403b and manually record the time location of each perceived occurrence of the joke in the video recording in step 404b. A third individual may analyze the video recording for gestures in accordance with FIG. 4. As the third individual views the video recording in step 401c, the third individual identifies each perceived instance of a gesture in step 402c. In step 403c, the third individual manually records a description of each perceived instance of a gesture (i.e., instance in which the speaker in the video recording scratches his or her nose) and the corresponding time location for each instance of a gesture in step 404c.

As shown in steps 102 and 103 of FIG. 1, the method of indexing a recordable event from a video recording may further include rating of a perceived recordable event in the video recording through human impression using a rating criterion. A rating criterion may include, but is not limited to a level of funniness, a level of seriousness, a level of inspiration, a level of passion, a level of audience reaction. FIG. 16 provides an example of a method of rating a recordable event through human impression using a rating criterion. In step 1602, the perceived recordable event may be rated through human impression using a level of funniness. In step 1603, the perceived recordable event may be rated through human impression using a level of inspiration. The perceived recordable event may be rated through human impression using a level of seriousness in accordance with step 1604. Optionally, the perceived recordable event may be rated through human impression using a level of passion in step 1605 and/or a level of audience reaction in step 1606. Then, the rating criterion is recorded in step 1607.

FIG. 5 and FIG. 6 provide examples of a level of funniness, a level of seriousness, a level of inspiration, a level of passion, a level of audience reaction. For example, the first individual may rate each perceived occurrence of an intellectual point on a level of seriousness and manually record the rating score for seriousness. The second individual may rate each occurrence of a joke in the video recording by a level of funniness. The second individual would manually record a rating score of funniness for each perceived occurrence of a joke.

Alternatively, the method of indexing a recordable event from a video recording comprises analyzing the video recording for a recoverable event through human impression by each of a member (i.e., record taker, note taker) of at least one group (i.e., team). FIG. 7 and FIG. 8 provide examples for a method of analyzing a video recording for a recordable event through human impression by each of a member of at least one group. According to steps 701a, 701b and 701c in FIG. 7, a first member, second member and third member may simultaneously view the video recording (i.e., a video recording of a football game, a video recording of a baseball game, a video recording of a wrestling match, a video recording of a basket ball game, a video recording of a basketball game). The first member may analyze the video recording with a focus on gestures. The second member may analyze the video recording for athletic performances and the third member may analyze the video recording for accidents. While viewing the video recording in accordance with step 701a, the first member may identify each perceived instance of a gesture in step 702a. The first member may manually record a description of each perceived instance of a gesture in step 703a and manually record a time location of each perceived instance of gesture (i.e., pausing, dancing, waving, falling on the floor, making a funny face) in step 704a that the first member identifies in the video recording. The second member may identify each perceived occurrence of athletic performance in the video recording in step 702b. The second member manually records a description of each perceived occurrence of the athletic performance (i.e., touch down in a video recording of a football game, home run in a video recording of a baseball game, knockout in a video recording of a wrestling match, three-pointer in a video recording of a basket ball game) in step 703b and manually records the time location corresponding to each perceived occurrence of athletic performance in step 704b. Similarly, the third member may identify each perceived occurrence of an accident in step 702c, manually record a description of each perceived occurrence of the accident (i.e., slip with left foot, slips with right foot) in step 703c and manually record the time location corresponding to each perceived occurrence of the accident in step 704c.

In an alternative method of indexing a recoverable event from a video recording, at least two individuals may analyze a video recording for at least one of a same recordable event through human impression. At least two individuals simultaneously view a video recording for at least one of a same recordable event and identify each perceived occurrence of recordable event. The at least two individuals record a description of each perceived occurrence of recordable event and corresponding time location for each perceived occurrence of recordable event. FIG. 9 provides an example of a method of analyzing a video recording for at least one of a same recordable event by at least two individuals through human impression. According to FIG. 9, a first individual and a second individual may simultaneously analyze the video recording for intellectual points through human impression. The first individual views the video recording in step 901a, identifies each perceived occurrence of an intellectual point in the video recording in step 902a, and manually records a description of each perceived occurrence of the intellectual point in step 903a and time location corresponding to each perceived occurrence of the intellectual point in the video recording in step 904a. The second individual views the video recording in step 901b. Then, the second individual identifies each perceived occurrence of an intellectual point in the video recording in step 902b. The second individual manually records a description of each perceived occurrence of the intellectual point in step 903a and manually records a time location corresponding to each perceived occurrence of the intellectual point in the video recording in step 904b. The records of the first individual are compared to the record of the second individual in step 905 and a maximum set of perceived occurrences of recordable events is determined in step 906.

In a preferred aspect, the method of indexing a recordable event from a video recording, comprises (a) analyzing a video recording for at least one of a same recoverable event through human impression by at least one member of a first group and at least one member of a second group. FIG. 10 illustrates an example of a method of analyzing a video recording for at least one of a same recoverable event through human impression by at least one member of a first group and at least one member of a second group. According to FIG. 10, the at least one member of the first group and the at least one member of the second group simultaneously view the video recording for at least one of the same recordable event such as an intellectual point in steps 1001a and 1001b. In step 1002a, the at least one member of the first group identifies each perceived occurrence of recoverable event through human impression. In steps 1003a and 1004a, the at least one member of the first group records a description of each perceived occurrence of recoverable event and records a corresponding time location for said perceived occurrence of recoverable event. In step 1002b, the at least one member of the second group identifies each perceived occurrence of recoverable event through human impression. The at least one member of the second group records a description of each perceived occurrence of recoverable event in step 1003b and records a corresponding time location for each perceived occurrence of recoverable event in 1004b. The record for the description of each perceived occurrence of recoverable event from the at least one member of the first group is compared to the record for the description of each perceived occurrence of recoverable event from the at least one member of the second group in step 1005 and a maximum set of description is determined in step 1006.

FIG. 11 shows the linking of various video sources to a computer 1113 for indexing of a recordable event from a video recording. A video recording, created from a video camera 1101 through software, e.g., computer-aided design (CAD) or computer aided manufacturing (CAM) software, provides one example of a video source, which may be indexed in accordance with the methods of the present invention. A video recording on a digital video disk (DVD) 1102 provides another example of a video source for indexing. A video recording may be downloaded from a network such as a local area network (LAN) or wide area network (WAN), e.g., Internet 1103, intranet 1104, or ethernet 1105 via digital subscriber line (DSL) 1110 and digital subscriber line modem 1114, asymmetric digital subscriber line (ADSL) 1111 and asymmetric digital subscriber line modem 1115, network card 1108, cable 1107 and cable modem 1106, high broadband, high-speed Internet access or other Internet access etc. For downloading video recordings from a network, by way of example, the computer 1113 may be connected to an outlet wall for the ethernet 1105 using a connection such as cordless telephone 1109.

The recordable event of a video recording is digitized on the hard drive of the computer in accordance with step 104 of FIG. 1. FIG. 12 illustrates the method of digitizing a recordable event of the video recording on the hard drive of the computer (e.g., personal computer (PC) such as an IBM® compatible personal computer, desktop, laptop, workstation such as a Sun® SPARC Workstation or microcomputer). The video recording is captured from a video source in step 1201 of FIG. 12. A hardware video digitizer receives the video recording from one or more video sources, e.g., video camera, random access memory (RAM), the Internet, intranet, ethernet, other server or network in step 1202. The hardware video digitizer determines whether the video recording is in a digital format or analog format in step 1203. If the video recording is already in a digital format, then the digital format of the video recording is stored on the hard drive of the computer for indexing of recordable events in step 1204. The hardware video digitizer is connected to a computer. The hardware video digitizer converts the analog format of the video recording to a digital format (e.g., a moving picture expert group format (MPEG) format, Real Player format) in step 1204. After the analog of the video recording is converted to the digital format of the video recording in step 1205, the digital format of the video recording is stored in the hard drive of the computer in step 1204. All video recordings to be indexed are stored on the hard drive(s) of the computer (e.g., personal computer (PC), desktop, laptop, workstation or microcomputer).

The method of indexing a recoverable event from a video recording through human impression includes digitally marking or tagging the recoverable event of the video recording on the hard drive of the computer (e.g., personal computer (PC), workstation or microcomputer) in step 105 of FIG. 1. FIG. 13 depicts a method of digitally marking or tagging the recoverable event of the video recording on the hard drive of the computer. The method includes embedding indexer keyword(s) into the video recording using an indexer input device in step 1302. According to step 1303, the indexer keyword(s) embedded into the video recording may comprise one or more criterion of a human impression analysis. A criterion of a human impression analysis is description of a recordable event, including, but not limited to a description of an intellectual point, a description of a quote, a description of a metaphor, a description of a joke, a description of a gesture, a description of an antic, a description of a laugh, a description of a concept, a description of a content, a description of a character, a description of an integration, a description of a sound, a description of a sourcing, a description of a story, a description of a question, a description of an athletic form, a description of an athletic performance, a description of a circus performance, a description of a stunt, a description of an accident. Alternatively in step 1304, the indexer keyword(s) embedded into the video recording may comprise one or more rating criterion (i.e., level of seriousness, level of funniness). Optionally, the indexer keyword(s) may comprise one or more criterion of human impression analysis and one or more rating criterion in accordance with steps 1303 and 1304.

FIG. 14 illustrates the method of associating a digitally tagged or marked recordable event with an indexer keyword on the hard drive of the computer (e.g., personal computer (PC), workstation or microcomputer) for search of video recording content. The recordable event is digitally marked or tagged in the video recording in step 1401 of FIG. 14. The digitally marked or tagged recordable event is associated with indexer keywords using an indexer input device e.g., pointing device, alphanumeric keyboard, mouse, trackball, touch screen, touch panel, touch pad, pressure-sensitive pad, light pen, joystick, other graphical user interface (GUI) or combination thereof in step 1402. The indexer input device may be used to scroll various menus or screens on the display device. The indexer may modify the marking or tagging of the recordable event in the video recording using the indexer input device in step 1403. The digital mark or tag on the recordable event may be removed using the indexer input device in step 1404. The indexer input device is used to move from one recoverable event to the next recordable event in step 1405. The next recordable event is digitally marked or tagged in the video recording in step 1401 and associated with the indexer keyword(s) describing the recordable event in step 1402.

An option is to link a workstation to one or more video source. FIG. 17 illustrates a method of digitizing a recordable event on a workstation. The video sources include, but are not limited to a hard drive, random access memory (RAM), the Internet, intranet, ethernet, other server or network. Incoming signals from a video recording are received by a hard drive video digitizer of the workstation in step 1701. According to steps 1702 and 1703, the recordable event is digitized onto the workstation and stored on the hard drive of the workstation where the indexing may be performed. The recordable event is digitally marked or tagged in the video recording in step 1704. The digitally marked or tagged recordable event is associated with indexer keywords in step 1705 using an indexer input device, e.g., pointing device, alphanumeric keyboard, stylus, mouse, trackball, cursor control, touch screen, touch panel, touch pad, pressure-sensitive pad, light pen, joystick, other graphical user interface (GUI) or combination thereof. The graphical user interface (GUI) may include one or more text boxes, fields or a combination thereof. Then, the digitally marked or tagged event recordable event is indexed on the hard drive of the workstation and a video digital library is compiled from one or more the digitally marked or tagged recordable events in step 1708. The marking or tagging of the recordable event in the video recording may be modified using the indexer input device in steps 1706 and 1707. The method includes moving from one digital mark or digital tag to another digital mark or digital tag via the indexer input device in step 1707.

The method of indexing recordable events from a video recording comprises compiling a digitally tagged or marked recoverable event in a database of recoverable events (i.e., computer index, computerized library, data repository, video digital library, digitized library) for searching and retrieving content of said video recording. FIG. 15 depicts a method of compiling a digitally tagged or marked recoverable event in a database of recoverable events for searching and retrieving content of a video recording in step 1501. Optionally, the method may include creating a plurality of databases on the hard drive of a computer for searching and retrieving video material. The method may further include providing a database identifier for each of a plurality of databases on the hard drive of the computer in step 1502. For example, a digital video library (DVL) may be created by compiling digitally tagged or marked recordable events using indexer keyword(s) (i.e., one or more criterion of a human impression analysis) and a user may input user keywords to search digitally tagged or marked recordable events. The digital video library (DVL) is stored on the hard drive of the computer in step 1506.

The method may include linking the digital video library (DVL) to a server in step 1503. The server may be connected to a network (e.g., Internet, intranet, ethernet) in step 1504. The server provides a stream of digital formatted video recording, which may be stored on the hard drive of the computer for indexing. In another aspect of the invention, the method may include linking the digital video library (DVL) to the workstation and server in step 1505. In still another aspect of the invention, the method may include linking the digital video library (DVL) to the workstation and a network (e.g., Internet, intranet, ethernet).

FIG. 18 is an exemplary embodiment of the video system. A processor 1803 (e.g., single chip, multi-chip, dedicated hardware of the computer, digital signal processor (DSP) hardware, microprocessor) is connected to the display device. The display device may include a plurality of display screens 1801 for prompting input, receiving input, displaying selection lists and displaying chosen video recordings. For example, a user may select a split screen key or button using a user input device. The selection of the split screen key or button causes multiple display screens or windows to appear on the display device. The computer 1802 has a random access memory (RAM) 1806. A random access memory controller interface 1804 is connected to a processor host bus 1805 and provides interface to the random access memory (RAM) 1806. A hard drive disk controller 1809 is connected to a hard drive 1808 of the computer. A video display controller 1809 is coupled to a display device 1801. An input device 1810 is coupled to the processor host bus 1805 and is controlled by the processor 1803.

The present invention provides a method of searching a video recording for a recordable event on a hard drive of a computer, said method comprising: (a) inputting a user defined criterion into a user input device; (b) processing said user defined criterion communicated to a processor; (c) comparing said user defined criterion to a recoverable event of a database of recoverable events; and (d) displaying a selection list of recoverable events matching said user defined criterion. FIG. 19 is block diagram illustrating a method of searching a database of recoverable events for recoverable events by inputting a user defined criterion using a user input device. In step 1901, the user inputs the user defined criterion using the user input device e.g., pointing device, alphanumeric keyboard, stylus, mouse, trackball, cursor control, touch screen, touch panel, touch pad, pressure-sensitive pad, light pen, joystick, other graphical user interface (GUI) or combination thereof. The user defined criterion may be natural language (e.g., one or more user keywords, a sentence). A processor (e.g., hardware of the computer, random access memory (RAM), digital signal processor (DSP) hardware, hard drive or non-volatile storage) receives the user defined criterion for processing in step 1902. For example, the user may input a user defined criterion using a touch screen. The processor receives a signal from the touch screen that identifies the location where the user touched an option on the touch screen. Since the processor is interfaced with the touch screen, the processor is capable of determining that the user has selected an option on the touch screen. The processor parses the user defined criterion such as a natural language sentence into an unstructured set of keywords in step 1903. In step 1904, the user defined criterion is automatically searched in the database of recoverable events by comparing the user defined criterion with the recordable events of the video recordings in the digitized library stored on the hard drive of the computer. The processor ranks the video recordings according to the recordable events that match the user defined criterion in step 1905. The video recording with the most recoverable events that match the user defined criterion is ranked first. The video recording with the least recoverable events that match the user defined criterion is ranked last. A display device is connected to the user input device.

Further in step 1906, a selection list of one or more recordable events that matches the user defined criterion, is displayed on a display device, e.g., a cathode ray tube (CRT), flat panel e.g. liquid crystal display (LCD), active matrix liquid crystal display (AMLCD), plasma display panel (PDP), electro luminescent display (EL) or field emission display (FED), computer monitor, television screen, personal digital assistant (PDA), hand-held (HHC) computer or other display screen capable of displaying video recordings output from the computer. According to step 1907, a video pointer identifies the time location for recordable events in the video recording. The user selects a video recording with the desired recordable events matching the user defined criterion in step 1908. In step 1909, the user may choose to play the video recording from the first recordable event that matches the user defined criterion. Alternatively in step 1909, the user may choose to play a video recording at a time location of a desired recordable event as identified by a video pointer. For example, the user may look through the last thirty minutes of an athletic event for instances where a particular event occurred such as a touch down, field goal, accident, foul, head butt, uppercut, three pointer, last stretch, strikeout, home run.

The present invention facilitates the analysis of performances and accidents. For example, the user may search a database of recoverable events and retrieve video recordings where an individual has slipped with the individual's right foot. The user may also search and retrieve video recordings with the individual's right hand movement. The video recordings of slips with the individual's right foot and video recordings of the individual's right hand movement may be analyzed to determine if the slips with the individual's right foot are statistically correlated to specific movement of the individual's right hand. Further, the present invention facilitates the analysis of video recording where an individual answers a question in a specific manner under one condition but answers the same question in a different manner under other conditions.

The method includes retrieving the video recordings, which contains the desired recordable events matching the user defined criterion in step 1910. The user may select the video recording for display using a digital video library (DVL) pointer, button, or user input device such as a pointing device, alphanumeric keyboard, stylus, mouse, trackball, cursor control, touch screen, touch panel, touch pad, pressure-sensitive pad, light pen, other graphical user interface (GUI) or combination thereof. The display device includes, but is not limited to a cathode ray tube (CRT), flat panel e.g. liquid crystal display (LCD), active matrix liquid crystal display (AMLCD), plasma display panel (PDP), electro luminescent display (EL) or field emission display (FED), computer monitor, television screen, personal digital assistant (PDA), hand-held (HHC) computer or other display screen capable of displaying video recordings output from the computer.

A database of recoverable events may be searched for a recordable event by inputting a user defined criterion such as a keyword into a graphical user interface. FIG. 20 depicts a diagram of a method of searching a database of recoverable events for a recordable event comprising inputting a user keyword into a graphical user interface. For example in step 2001 of FIG. 20, the user may input into the graphical user interface (GUI) one or more user keywords, describing the event which the user desires to search. In steps 2002 and 2003, the processor receives the user keyword or user keywords and compares the user keyword or user keywords to recordable events of video recordings in the digital video library, which is stored on the hard drive of the computer. As shown in FIG. 2, recordable events of the video recording include, but are not limited to an intellectual point, a quote, a metaphor, a joke, a gesture, an antic, a laugh, a concept, a content, a character, an integration, a sound, a sourcing, a story, a question, an athletic form, an athletic performance, a circus performance, a stunt, an accident. The processor ranks the video recording in step 2004. Video recordings are ranked in descending order based on the number of recordable events matching the user keyword or user keywords. Video recordings, which contain the most recordable events, matching the user keyword or user keywords, are ranked above video recordings, which contain the least recordable events, matching the user keyword or user keywords. In step 2005, the processor builds a selection list of recordable events. The user may choose the desired video recordings, which contains the recoverable events matching one or more user keywords using a graphical user interface (GUI) in accordance with step 2008. When the user chooses a video recording by using the user input device, the user may play the video recording on the display screen beginning at the portion of the video recording where the first recordable event in the video recording matches the user keyword or user keywords in accordance with step 2009. As indicated in step 2009, the user has the option of playing the video recording starting from a time location of a desired recordable event as identified by video pointer. The method includes displaying of the video recordings, which contains the recoverable events matching one or more user keywords on the display device. The display device including, but is not limited to a cathode ray tube (CRT), flat panel e.g. liquid crystal display (LCD), active matrix liquid crystal display (AMLCD), plasma display panel (PDP), electro luminescent display (EL) or field emission display (FED), computer monitor, television screen, personal digital assistant (PDA), hand-held (HHC) computer or other display screen capable of displaying video recordings output from the computer.

According to steps 2101, 2102 and 2103 in FIG. 21, an option is to remove articles (i.e., “a”, “an”, “the”) from the user defined criterion after the user has input the user defined criterion using the input device. The articles will not be processed by the processor. Then, the user defined criterion is automatically searched in the indexed medium in step 2106. For example, the article, “the” would be removed from the user defined criterion, “Bill Clinton is running for the White House”.

As shown in step 2104 of FIG. 21, another option is to remove helping verbs (i.e., “do”, “does”, “did”, “will”, “can”, “shall”, “should”, “could”, “would”, “may”, “must”, “might”, “be”, “being”, “been”, “am”, “is”, “was” “were” “have”, “had”, “has”) from the user defined criterion, which will be processed by the processor. After the helping verbs are removed, the user defined criterion is automatically searched in the indexed medium in step 2106. For instance, the helping verb, “is” would be removed from the user defined criterion, “Bill Clinton is running for President”.

Step 2105 of FIG. 21 provides yet another option of removing prepositions (i.e., “about”, “across”, “after”, “against”, “along”, “among”, “around”, “at”, “before”, “below”, “beneath”, “between”, “behind”, “beside”, “beyond”, “but”, “despite”, “down”, “during”, “except”, “for”, “from”, “in”, “inside”, “into”, “like”, “of”, “off”, “on”, “out”, “outside”, “over”, “Past”, “since”, “through”, “throughout”, “till”, “near”, “to”, “toward”, “underneath”, “until”, “up”, “with” and “without” from the user defined criterion and perform an automatic search. For example, if the user inputs the user defined criterion, “Bill Clinton is running for the White House”, an automatic search would be performed in the indexed medium for the user defined criterion, “Bill Clinton is running the White House”.

Alternatively, articles, helping verbs and/or prepositions may be removed from the user defined criterion in accordance with steps 2103, 2104, and 2105. For example, the article, “the”, the helping verb, “is” and the preposition, “for” would be removed from the user defined criterion, “Bill Clinton is running for the White House”. Thus, an automatic search would be performed in the indexed medium for the user defined criterion, “Bill Clinton running White House”.

Another aspect of the present invention provides a method of searching a video recording for a recordable event on a hard drive of a computer, said method comprising: (a) inputting a user defined criterion into a user input device; (b) creating a composite list from said user defined criterion; (c) processing said user composite list communicated to a processor; (d) comparing said composite list to a recoverable event of a database of recoverable events; and (e) displaying a selection list of recoverable events matching said composite list. The composite list may be created using a computerized thesaurus by generating words that are synonyms and/or related to the user defined criterion in step 2206 of FIG. 22. For example, if the user inputs a user defined criterion such as “tennis match”, then the composite list might include “tennis game”, “tennis contest”, “tennis bout”, “tennis event” etc. The composite list might include “prizefight” and/or “glove game” where the user inputs the user defined criterion of “boxing”. If the user inputs a user defined criterion such as “circus”, then, the composite list might include “big top”, “three ring”, “fair”, “festival”, “bazaar”, “spectacle” etc. The user defined criterion, “dinner” might generate a composite list containing “banquet”, “supper”, “chow”, “eats”, “feast”, “pot luck” etc. Where the user inputs the user defined criterion “robbery”, the composite list might include “breaking and entering”, “burglary”, “hold up”, “stickup”, “caper”, “heist”, “prowl”, “safe cracking”, “theft”, “stealing” etc. The database such as a digitized library is automatically searched using the composite list in step 2207. In step 2207, the method includes comparing the composite list to the recordable events of the video recording in the digitized library. The video recording, which contains the most recordable events matching the composite list are ranked first. The video recording, which contains the least number of recordable events matching the composite list is ranked last. The user selects the video recording with the desired recordable events matching the composite list in step 2211. The method includes retrieving and displaying the video recordings, which contains the desired recordable events matching the composite list in step 2212. The user may start playing the video recording from the first desired recordable event, matching the composite list, or the user may start playing the video recording from the desired recordable event, matching the composite list, at a time location identified by a video pointer in step 2212.

A further option is to remove articles in step 2203, remove helping verbs in step 2204 and/or prepositions from the user defined criteria in step 2205 and generate a composite list of synonyms and/or related words for the user defined criterion in step 2206. For instance, the composite list might include “Bill Clinton”, “running”, “operating” “active”, “functioning”, “executing” “succeeding”, “administrating”, “White House”, “President” “executive branch” “executive mansion”, “executive palace” etc. where the user inputs the user defined criterion, “Bill Clinton is running for the White House”.

What is claimed is:

1. A method of indexing a recordable event from a video recording, said method comprising:
analyzing said video recording for said recoverable event through human impression;
digitizing said recordable event on a hard drive of a computer;
digitally tagging or marking said recordable event of said video recording on said hard drive of said computer;
associating a digitally tagged or marked recoverable event with an indexer keyword; and
compiling said digitally tagged or marked recoverable event in a database of recoverable events for searching and retrieving content of said video recording.

2. The method of claim 1, further comprising rating said perceived recoverable event through human impression using a rating criterion.

3. The method of claim 2, wherein said rating criterion is selected from the category consisting of: a level of funniness, a level of seriousness, a level of inspiration, a level of passion, a level of audience reaction or a combination thereof.

4. The method of claim 2, wherein said rating criterion is manually recorded.

5. The method of claim 1, wherein said analyzing includes
viewing said video recording by at least one individual or at least one group;
identifying a perceived occurrence of recoverable event through human impression;
recording a description of said perceived occurrence of recoverable event; and
recording a corresponding time location for said perceived occurrence of recoverable event.

6. The method of claim 5, wherein said recording of said perceived occurrence of recordable event is manual recording.

7. The method of claim 5, wherein said recording of said corresponding time location for said perceived occurrence of recordable event is manual recording.

8. The method of claim 1, wherein said analyzing includes
viewing said video recording by each of a member of at least one group;
identifying a perceived occurrence of recoverable event through human impression;
recording a description of said perceived occurrence of recoverable event; and
recording a corresponding time location for said perceived occurrence of recoverable event.

9. The method of claim 1, wherein said analyzing includes
viewing said video recording by at least two individuals;
identifying a perceived occurrence of at least one of a same recoverable event through human impression;
recording a description of said perceived occurrence of said at least one of same recoverable event; and
recording a corresponding time location for said perceived occurrence of said at least one of said same recoverable event.

10. The method of claim 9, wherein said analyzing further includes
comparing a record of said description of said perceived occurrence of said at least one of said same recoverable event from at least two individuals; and
determining a maximum set of records.

11. The method of claim 1, wherein said analyzing includes
viewing said video recording by at least one of a member of a first group and at least one of a member of a second group;
identifying a perceived occurrence of at least one of a same recoverable event through human impression;
recording a description of said perceived occurrence of said at least one of same recoverable event; and
recording a corresponding time location for said perceived occurrence of said at least one of said same recoverable event.

12. The method of claim 11, wherein said analyzing further includes
comparing a record of said description of said perceived occurrence of said at least one of said same recoverable event from said at least one of said member of said first group with a record of said description of said perceived occurrence of said at least one of said same recoverable event from said at least one of said member of second first group; and
determining a maximum set of records.

13. The method of claim 1, wherein said analyzing includes
identifying at least one of a recordable event selected from the category consisting of:
an intellectual point, a quote, a metaphor, a joke, a gesture, an antic, a laugh, a concept, a content, a character, an integration, a sound, a sourcing, a story, a question, an athletic form, an athletic performance, a circus performance, a stunt, an accident.

14. The method of claim 1, wherein said digitizing of said recordable event includes
capturing said video recording from a video source;
receiving said video recording from said video source by a hard drive digitizer;
determining whether said video recording is in a digital format; and
converting an analog format of said video recording to said digital format using said hard drive video digitizer.

15. The method of claim 14, wherein said digitizing of said recordable event from a video recording on the hard drive of a computer includes storing said digital format of video recording on said hard drive of said computer.

16. The method of claim 1, wherein said digitally tagging or marking said recordable event of said video recording on said hard drive of said computer includes embedding at least one of said indexer keyword into said video recording.

17. The method of claim 16, wherein said indexer keyword is a criterion of human impression.

18. The method of claim 16, wherein said indexer keyword is a rating criterion.

19. The method of claim 1, wherein said indexer input device is selected from a group consisting of a pointing device, an alphanumeric keyboard, a stylus, a mouse, a trackball, a cursor control, a touch screen, a touch panel, a touch pad, a pressure-sensitive pad, a light pen, a joystick, a graphical user interface (GUI), and a combination thereof.

20. The method of claim 1, wherein said indexer keyword is at least one of a criterion of human impression analysis.

21. The method of claim 20, wherein said at least of one of said criterion of human impression is selected from the category consisting of: a description of an intellectual point perceived through human impression, a description of a quote perceived through human impression, a description of a metaphor perceived through human impression, a description of a joke perceived through human impression and a combination thereof.

22. The method of claim 20, wherein said at least of one of said criterion of human impression is selected from the category consisting of: a description of a gesture perceived through human impression, a description of an antic perceived through human impression, a description of a laugh perceived through human impression, a description of a concept perceived through human impression, a description of a content perceived through human impression and a combination thereof.

23. The method of claim 20, wherein said at least of one of said criterion of human impression is selected from the category consisting of: a description of a character perceived through human impression, a description of an integration perceived through human impression, a description of a sound perceived through human impression, a description of a sourcing perceived through human impression, a description of a story perceived through human impression and a combination thereof.

24. The method of claim 20, wherein said at least of one of said criterion of human impression is selected from the category consisting of: a description of a description of a question perceived through human impression, a description of an athletic form, a description of an athletic performance, a description of a circus performance perceived through human impression, a description of a stunt perceived through human impression, a description of an accident perceived through human impression, and a combination thereof.

25. The method of claim 1, wherein said indexer keyword is at least one of a rating criterion.

26. The method of claim 25, wherein said at least of one of said rating criterion is selected from the category consisting of: a level of funniness, a level of seriousness, a level of inspiration, a level of passion, a level of audience reaction, and a combination thereof.

27. The method of claim 1, further comprising modifying a digitally tagged or marked recoverable events by removing a digital tag or mark using an indexer input device.

28. The method of claim 1, wherein said database of recoverable events is a digitized library.

29. The method of claim 1, wherein said computer is a workstation.

30. The method of claim 1, wherein said computer is a personal computer.

31. The method of claim 1, said associating of said digitally tagged or marked recordable event with said indexer keyword further includes modifying said digitally tagged or marked recoverable event using said indexer input device.

32. The method of claim 1, said associating of said digitally tagged or marked recordable event with said indexer keyword further includes removing said tagged or marked recoverable event using said indexer input device.

33. The method of claim 1, said compiling said digitally tagged or marked recoverable event in said database of recoverable events for searching and retrieving content of said video recording includes providing a database identifier for said database of recoverable events.

34. The method of claim 33, said compiling said digitally tagged or marked recoverable event in said database of recoverable events for searching and retrieving content of said video recording further includes linking said database of recoverable events to at least of a server, network, workstation and a combination thereof.

35. The method of claim 33, said compiling said digitally tagged or marked recoverable event in said database of recoverable events for searching and retrieving content of said video recording further includes storing said database of recoverable events on said hard drive of said computer.

36. A method of searching a video recording for a recordable event on a hard drive of a computer, said method comprising:
inputting a user defined criterion into a user input device;
processing said user defined criterion communicated to a processor;
comparing said user defined criterion to a recoverable event of a database of recoverable events; and
displaying a selection list of recoverable events matching said user defined criterion.

37. The method of claim 36, further comprising parsing said user defined criterion for at least one of a article, helping verb, preposition and a combination thereof.

38. The method of claim 36, further comprising ranking video recordable by a frequency of recoverable events matching said user defined criterion.

39. The method of claim 36, further comprising providing a time location of recoverable event using a video pointer.

40. The method of claim 36, further comprising selecting a video recording of desired recoverable events matching said user defined criterion.

41. The method of claim 36, further comprising retrieving a video recording of desired recoverable events matching said user defined criterion.

42. The method of claim 36, further comprising displaying a video recording of desired recoverable events matching said user defined criterion on a display device from a first desired recoverable event matching user defined criterion.

43. The method of claim 36, further comprising displaying a video recording of desired recoverable events matching said user defined criterion on a display device from a time location identified by a pointer.

44. The method of claim 36, further comprising playing a video recording of desired recoverable events matching said user defined criterion on a display device from a first desired recoverable event matching user defined criterion.

45. The method of claim 36, further comprising playing a video recording of desired recoverable events matching said user defined criterion on a display device from a time location identified by a pointer.

46. The method of claim 36, wherein said database of recoverable events is a digitized library.

47. The method of claim 36, wherein said user defined criterion is a user keyword, natural language, a combination thereof.

48. The method of claim 36, wherein said user input device is a graphical user interface.

49. A method of searching a video recording for a recordable event on a hard drive of a computer, said method comprising:
inputting a user defined criterion into a user input device;
creating a composite list from said user defined criterion;
processing said user composite list communicated to a processor;
comparing said composite list to a recoverable event of a database of recoverable events; and
displaying a selection list of recoverable events matching said composite list.

50. The method of claim 49, further comprising parsing said user defined criterion for at least one of a article, helping verb, preposition and a combination thereof.

51. The method of claim 49, further comprising ranking video recordable by a frequency of recoverable events matching said composite list.

52. The method of claim 49, further comprising providing a time location of recoverable event using a video pointer.

53. The method of claim 49, further comprising selecting a video recording of desired recoverable events matching said composite list.

54. The method of claim 49, further comprising retrieving a video recording of desired recoverable events matching said composite list.

55. The method of claim 49, further comprising displaying a video recording of desired recoverable events matching said composite list on a display device from a first desired recoverable event matching said composite list.

56. The method of claim 49, further comprising displaying a video recording of desired recoverable events matching said composite list on a display device from a time location identified by a pointer.

57. The method of claim 49, further comprising playing a video recording of desired recoverable events matching said composite list on a display device from a first desired recoverable event matching composite list.

58. The method of claim 49, further comprising playing a video recording of desired recoverable events matching said composite list on a display device from a time location identified by a pointer.

59. The method of claim 49, wherein said database of recoverable events is a digitized library.

60. The method of claim 49, wherein said user defined criterion is at least one of a user keyword, natural language, a combination thereof.

61. The method of claim 49, wherein said user input device is a graphical user interface.
